(19) United States
(12) Patent Application Publication
(10) Pub. No.: US 2023/0297970 A1
(43) Pub. Date: Sep. 21, 2023

(54) INTELLIGENT SCHEDULING OF MAINTENANCE TASKS TO MINIMIZE DOWNTIME

(71) Applicant: Red Hat, Inc., Raleigh, NC (US)

(72) Inventors: Brian Gallagher, Waterford (IE); Cathal O'Connor, Waterford (IE)

(21) Appl. No.: 17/695,182

(22) Filed: Mar. 15, 2022

(51) Int. Cl. G06Q 10/00; G06Q 10/06

(52) U.S. Cl. CPC G06Q 10/20; G06Q 10/06311

(57) ABSTRACT

Processing logic may generate metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components. Processing logic may obtain a notification to perform a maintenance task for a first of the plurality of components. In view of the metadata, processing logic may schedule the maintenance task for the first of the plurality of components to coincide with a second maintenance task of the second of the plurality of components.

### TECHNICAL FIELD

Aspects of the present disclosure relate to performing maintenance tasks for an application, and more particularly, to scheduling maintenance tasks in view of metadata generated from previously performed maintenance tasks.

### BACKGROUND

Computing devices may be communicatively coupled to each other over a network, which may include electrical or optical wiring, wireless radio-frequency transceivers, or other network infrastructure. Computing devices may execute instructions that are grouped together to provide related functionality to a user. The related functionality may be understood as an application. Some applications may run on a network connected server and be available to clients that are also connected to the network. Maintenance of such an application may be performed live, for example, on the server or servers that the application is deployed to.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows a block diagram of a computing device that may schedule maintenance tasks for an application in accordance with some embodiments.

FIG. 2 shows an example method for scheduling maintenance tasks for components, in accordance with some embodiments.

FIG. 3 shows an example workflow for generating metadata, in accordance with some embodiments.

FIG. 4 shows an example workflow for scheduling maintenance tasks of components in view of metadata, in accordance with some embodiments.

FIG. 5 illustrates an example of scheduling logic in accordance with some embodiments.

FIG. 6 shows an example method for scheduling maintenance tasks for components, in accordance with some embodiments.

FIG. 7 shows an example method for scheduling maintenance tasks for components, in accordance with some embodiments.

FIG. 8 is a block diagram of an example computing device that may perform one or more of the operations described herein, in accordance with some embodiments.

### DETAILED DESCRIPTION

Maintenance of such an application may be performed live, for example, on the server or servers that the application is deployed to. In some cases, the act of performing the maintenance may reduce performance or functionality of the application, or result in downtime of the application. An application may perform maintenance tasks such as software updates, memory checks, modifications to configuration files or other resources, adding features, generating or checking log files, or other maintenance tasks. An application may experience downtime as a result of such maintenance tasks. Further, modern day applications may run in a hybrid cloud environment and comprise multiple independently deployable and serviceable components (e.g., a microservices application) that may be distributed over one or more computing devices (e.g., servers). Each of these components may independently run its own maintenance task.

As the number of components grows for a given application, the downtime experienced by the application may also grow. For example, as each component independently performs its maintenance task, some of these components may experience downtime which may result in downtime of other components, which may ultimately result in an overall downtime of the application. Further, applications may operate under a service level agreement (SLA) or a service level objective (SLO) that indicates an acceptable downtime of an application. It is desirable to schedule maintenance tasks for components of an application in a manner that reduces the impact of these maintenance tasks on the overarching application.

In conventional systems, scheduling of maintenance tasks for components may be performed in view of static rules that may indicate priority of some maintenance tasks over others depending. The scheduling may be performed in view of criticality or other static criteria that may be set by an author of the maintenance task. Such systems fail to schedule the maintenance tasks in view of historical performance. Further, such systems do not account for downtimes on a per-component basis which may be determined in view of historical data (e.g., prior maintenance tasks). Further, such systems fail to capture and consider interdependencies between components when scheduling maintenance tasks.

Aspects of the disclosure address the above-noted issues and other deficiencies, by monitoring the downtime of various components of an application in response to maintenance tasks to determine interdependencies between the various components and sensitivities of each component to different types of maintenance tasks. When a component signals needs to perform a maintenance task, processing logic may schedule the maintenance task with other maintenance tasks in view of the interdependencies and sensitivities, to reduce an overall downtime of the application. For example, pending maintenance tasks for components that are interdependent to each other may be scheduled together by processing logic.

Although the application may still experience some downtime when the interdependent components are scheduled together, this downtime may be less than if the maintenance tasks were instead scheduled separately at different times. Other aspects are described herein that may further reduce the impact of the maintenance tasks on the application, improve the performance of the scheduling, or provide other benefits related to the scheduling of the maintenance tasks.

Processing logic may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. Processing logic may be integral to any of the nodes in a mesh network.

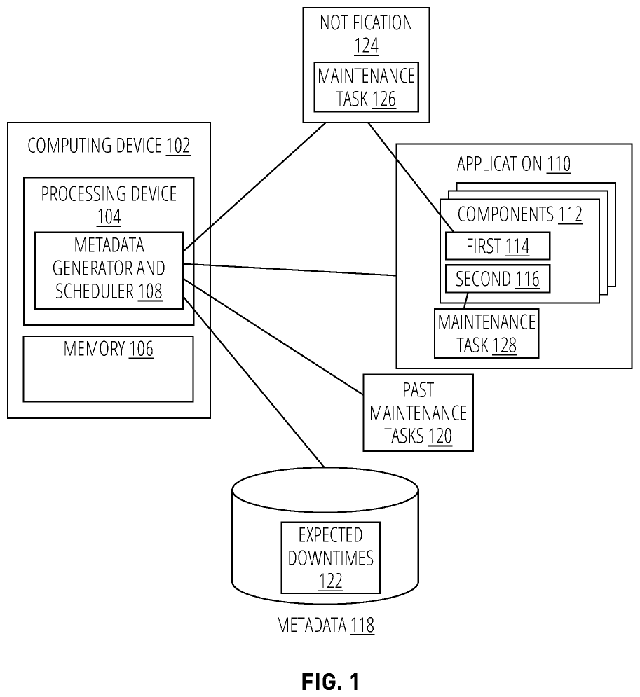

FIG. 1 shows a block diagram of a computing device 102 that may schedule maintenance tasks for an application 110 in accordance with some embodiments. Computing device 102 includes a processing device 104 and a memory 106. Memory 106 may include volatile memory devices (e.g., random access memory (RAM)), non-volatile memory devices (e.g., flash memory) and/or other types of memory devices. Computing device 102 may include processing logic such as processing device 104.

Processing device 104 includes a metadata generator and scheduler 108. Metadata generator and scheduler 108 may monitor behavior of application 110 in response to past maintenance tasks 120 and generate metadata 118 in view of the monitored behavior.

Application 110 may include a plurality of components 112 that work together to provide related functionality. Each of components 112 may be independently deployable and serviceable. In some examples, application 110 may have a microservices architecture which allows development and maintenance to be performed by and for each component individually without fully redeploying or shutting down the entire application. As such, each component may, in some examples, be understood as a service, and each service may operate in a containerized environment. Unlike application development in monolithic architectures, individual microservices of a microservices application may be built by small teams with the flexibility to choose their own tools and coding languages. Microservices of a common application may be built independently of each other, communicate with each other, can individually fail, and individually be modified and redeployed. Thus, an upgrade or fix to part of the application may not necessarily result in an application-wide downtime.

Downtime of an application may be understood as reduced functionality or operability. In some cases, downtime of the application may mean complete inoperability (e.g., the application is unresponsive or not executing). In other cases, downtime of the application may mean that the application is partially inoperable, for example, the application no longer performs as intended, is working slower, has reduced capabilities, or does not meet standards that may be defined by an SLA or SLO.

As mentioned, each of the components 112 may have individual maintenance tasks that are to be performed by and for each component, to add or update functionality, fix software bugs, update security or vulnerability issues, or address other issues through that component. The processing device 102 may monitor communications between components, or monitor other indicators of the responsiveness or behavior of each component.

When each of the maintenance tasks are performed, some or all of the components may experience downtime. Downtime of a single component may mean that the component is unresponsive, or that it does not perform as intended, or that performance is reduced, or a combination thereof. Downtime of a single component may or may not result in the overall downtime of the overarching application 110. Similarly, downtime of one component may or may not result in downtime of another component.

The processing device 104 may monitor the components to determine which of the components experience downtime, if any. The processing device 104 may record when each downtime of each component occurs, and for how long each downtime lasts. The processing device may use a machine learning model to determine interdependencies between the components 112, and expected downtimes 122 of each of the components where each of those expected downtimes may be in response to a classification of each of the maintenance tasks. Thus, the metadata 118 may serve as a scheduling guide to processing device 102. The metadata indicates what expected downtimes 122 to expect from a given component in response to a given maintenance task or classification of that maintenance task.

The processing device 104 may obtain a notification 124 to perform a maintenance task 126 for a first (114) of the plurality of components 112. In some examples, the notification 124 may be sent by a networked computing device. In some examples, the notification 124 may be generated by the respective component for which the maintenance task is to be performed. For example, the first (114) of the plurality of components 112 may raise a notification 124 that requests that the processing device 104 schedule the maintenance task 126.

The processing device may reference the metadata 118 in view of the maintenance task 126, the metadata indicating an expected downtime the first (114) of the plurality of components and a second expected downtime of a second (116) of the plurality of components in response to the expected downtime of the first of the plurality of components. For example, metadata 118 may indicate interdependencies between the components 112 such as second component 116 having a strong likelihood of experiencing downtime in response to downtime of first component 114. The expected downtimes 122 of the first and second component may be stored and retrievable in metadata 118 in view of component identifier (e.g., a name) and a classification of the maintenance task.

The processing device 104 may schedule the maintenance task 126 for the first (114) of the plurality of components to coincide with a second maintenance task 128 of the second (116) of the plurality of components. In such a manner, the processing device 104 may reduce an overall downtime of application 110, by scheduling maintenance of interdependent components together. As described in other sections, the processing device 104 may store tasks such as the second maintenance task 128 in a task database, and these stored maintenance tasks may be scheduled to run such that the overall downtime of the application 110 is reduced. For example, these stored maintenance tasks may be run opportunistically, when another maintenance task is to be run on a component and has an expected downtime that is also expected to cause a downtime of the component on which the stored maintenance task is to be run on. These downtimes may be scheduled to occur at the same time so that downtime resulting from multiple maintenance tasks is not spread.

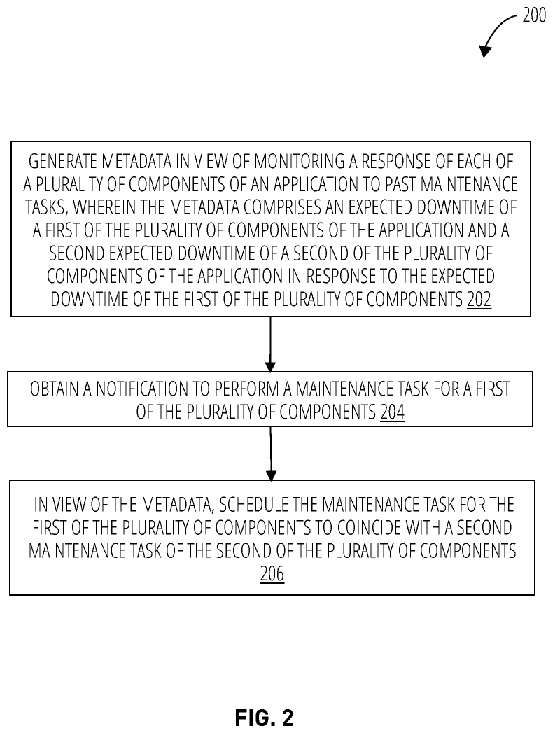

FIG. 2 is a flow diagram of a method 200 for scheduling maintenance tasks for components, in accordance with some embodiments. Method 200 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 200 may be performed by metadata generator and scheduler 108 of FIG. 1.

With reference to FIG. 2, method 200 illustrates example functions used by various embodiments. Although specific function blocks (“blocks”) are disclosed in method 200, such blocks are examples. That is, embodiments are well suited to performing various other blocks or variations of the blocks recited in method 200. It is appreciated that the blocks in method 200 may be performed in an order different than presented, and that not all of the blocks in method 200 may be performed.

At block 202, processing logic may generate metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components.

At block 204, processing logic may obtain a notification to perform a maintenance task for a first of the plurality of components. At block 206, in view of the metadata, processing logic may schedule the maintenance task for the first of the plurality of components to coincide with a second maintenance task of the second of the plurality of components.

In some examples, at block 202, generating the metadata includes identifying, by processing logic, which of the plurality of components experienced a downtime in response to the past maintenance tasks. For example, as described with respect to FIG. 1, processing logic may monitor the performance of past maintenance tasks and record that component 114 experienced an average downtime of ‘x’ minutes in response to each of the maintenance tasks or a particular class of maintenance tasks. Processing logic may feed records of the downtime of the plurality of components to a machine learning model in response to the past maintenance tasks. Each of the records may include a time that the downtime occurred, which component experienced the downtime, and a duration of the downtime.

Processing logic may classify each of these past maintenance tasks, and feed the classification of the past maintenance task to the machine learning model with each associated record, to train the machine learning model to associate the downtime of each of the plurality of components to each of the classifications for that respective component. For example, for component A, a maintenance task with classification A may be associated with an expected downtime of ‘x’ minutes. For the same component A, a maintenance task with a different classification B may be associated with a different expected downtime of ‘y’ minutes or no expected downtime at all. The records and classifications may be understood as training data for the machine learning model. The machine learning model may generate resulting metadata which may have the interdependencies between components of the application, as well as the response of each component to a classification of a given maintenance task. Such a response indicates whether or not a given component will likely experience downtime in response to that classification of maintenance task, and what the duration of that expected downtime is, if any.

An author of a given maintenance task (e.g., a developer) may assign a classification to a given maintenance task, and this classification may be included in the notification or otherwise associated with the maintenance task. The classification may describe the size of impact that the maintenance task will have on the component, or it may describe the purpose of the maintenance task. Examples of classifications include, but are not limited to: a major version release, a minor version release, a patch version release, a routine maintenance, and a common vulnerabilities and exposures (CVE) upgrade. Processing logic may use the classification to generate and retrieve the metadata (e.g., as training data).

In some examples, the machine learning model may include a time series clustering algorithm. Time series clustering may be understood as an unsupervised data mining technique that may group subjects based on their similarity. The time series clustering algorithm groups subjects in a dataset such that the similarity in grouped subjects that form each cluster are maximized and similarity across different clusters are minimized. The machine learning model may include time as a distance metric in the time series clustering algorithm such that temporally aligned downtimes of different components are clustered together. This alignment need not be exact, and tolerances of the clustering may be changed by modifying parameters such as the distance metric.

In some examples, at block 204, the notification to perform the maintenance task may be a message sent by the respective component on which the maintenance task is to performed on. For example, if the maintenance task is targeted to be performed on or by component A of an application, then component A may send a message (e.g., a notification or request) to processing logic to schedule the maintenance task. In some examples, the notification may be obtained from a different source, for example, from a computing device that manages administrative tasks, which may be configured by a user (e.g., an administrator). The notification may include a classification of the maintenance task. For example, the notification may specify if the maintenance task is a major version release, a minor version release, a patch version release, a routine maintenance, or a CVE upgrade.

In some examples, at block 206, referencing the metadata in view of the maintenance task includes referencing, by processing logic, a classification of the maintenance task with respect to a first of the plurality of components in the metadata to determine whether the first of the plurality of components has an expected downtime in response to the maintenance task and which of the plurality of components is expected to have a second expected downtime in response to the expected downtime of the first of the plurality of components.

For example, if the maintenance task that is to be scheduled for component A has a classification of ‘major version release’, then processing logic may look up the response of component A to a ‘major version release’ in the metadata. The metadata may indicate that component A has an expected downtime of ‘x’ minutes in response to a ‘major version release’. The metadata may further indicate that component B is expected to have a downtime of ‘y’ minutes in response to downtime of component A.

In some examples, at block 206, scheduling the maintenance task includes scheduling, by the processing logic, a first maintenance task of a first of the plurality of components concurrent with the second maintenance task of a second component, in response to the second maintenance task having an expected downtime that is smaller than the first maintenance task or the second maintenance task having an expected downtime that is greater than the first maintenance task of the other component but by less than a threshold amount. For example, if processing logic receives a notification to schedule maintenance task A to be performed on component A, processing logic may schedule maintenance task A to coincide with maintenance task B that is to be performed for component B, in response to the expected downtime of maintenance task B being smaller than maintenance task A or if maintenance task B is greater than maintenance task A, but by less than a threshold amount. The expected downtimes may be referenced by processing logic from metadata, as described.

In some examples, at block 206, scheduling the maintenance task includes referencing, by the processing device, a set of rules. The rules may be configurable by a user such as a system administrator to provide guidance on when to perform a given maintenance task. The rules may specify that some classifications are to be performed immediately while others may be put on hold. For example, the rules may specify that a ‘major version release’ must be performed within ‘x’ hours of a notification. The rules may specify that a ‘CVE upgrade’ is to be performed immediately. The rules may vary from one application to another.

In some examples, processing logic may schedule the maintenance task for a component for immediate performance, in response to the component not having an expected downtime in response to that maintenance task. For example, processing logic may obtain a notification to perform maintenance task A on component A. Processing logic may reference metadata which indicates that maintenance task A having a classification of ‘routine maintenance’ is expected to have zero downtime. In response to the lack of expected downtime, processing logic may schedule maintenance task A for component A to be performed by or on the component immediately.

In some examples, processing logic may queue a maintenance task for manual analysis. For example, processing logic may store the maintenance task in a queue that is accessible for a user to view. In some examples, this may be performed in response to the classification of the maintenance task, or other information in the notification or in configurable rules. The user may manually tag the queued maintenance task with additional information such as ‘apply immediately’, ‘schedule’, or ‘ignore’. Processing logic may use take the maintenance task from the queue after it has been tagged and schedule the maintenance task according to the tag.

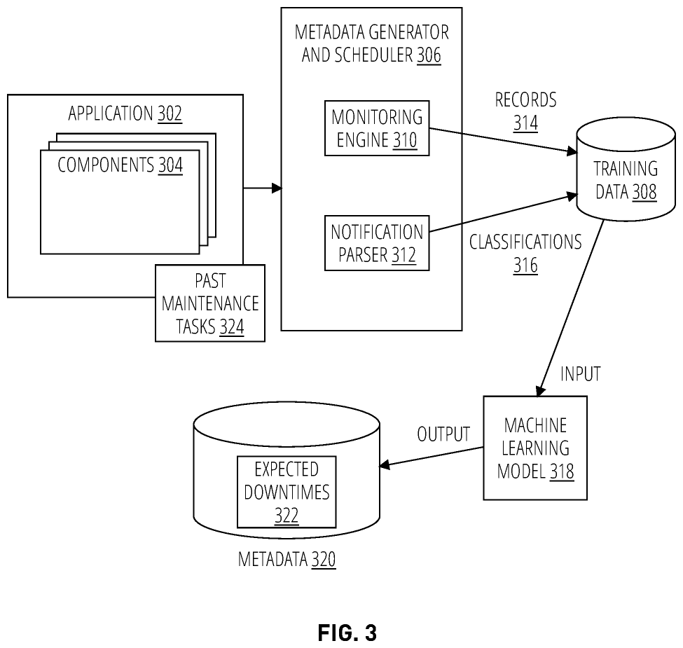

FIG. 3 shows an example workflow for generating metadata, in accordance with some embodiments. An application 302 may have a plurality of components 304. The components 304 may be independently deployable and independently serviceable. The components 304 may be services that communicate with each other to form an overarching product or service which may be referred to as the application 302. In some examples, the components 304 may be deployed across multiple disparate deployment environments.

Metadata generator and scheduler 306 may have a monitoring engine 310 that monitors the behavior of application 302 and its components 304, when the components are performing past maintenance tasks 324. Monitoring engine 310 may record the uptime and downtime of each of the components 304, and make a record 314 that includes when a given component experiences downtime and for how long that component goes down. Each record may be associated with a component identifier such as a name or other identifier of the component.

Notification parser 312 may monitor notifications that are made by each of the components prior to performance of each of the past maintenance tasks, to obtain a classification 316 for each of the past maintenance tasks. As such, the metadata generator and scheduler 306 may listen to and monitor the application 302 and its components 304 to obtain records that indicate downtimes of the components 304 and application 302 in response to various classifications of the past maintenance tasks as performed on each of the components 304. Each component may have a unique response to different classifications of maintenance tasks.

The records 314 and classifications 316 of each of the past maintenance tasks 324 may be used as training data 308 which is input to a machine learning model 318. As discussed, the machine learning model 318 may include a time series clustering algorithm. Time series clustering may group subjects (e.g., components) according to their similarity or distance. The time series clustering algorithm groups subjects in a dataset such that the similarity in grouped subjects that form each cluster are maximized and similarity across different cluster are minimized.

Further, each of the maintenance tasks and associated expected downtimes may be associated with the classification 316. For example, metadata 320 may indicate that, for component A, a ‘major version release’ has an expected downtime of 15 minutes, which may be an average or median in view of the historical data. Metadata 320 may further indicate that, for component A, a ‘patch version release’ has no expected downtime. Metadata 320 may further indicate that, for component B, a ‘minor version release’ has an expected downtime of 5 minutes. Thus, each component may have an expected downtime (if any) for each classification of maintenance task.

In some examples, each of the maintenance tasks in the training data 308 is classified as one of: a major version release, a minor version release, a patch version release, routine maintenance, or a CVE upgrade. In such a manner, the machine learning model 318 may process the training data 308 to gain valuable insight as the effect of each distinct maintenance task on a particular component in the system. Such insights may include, for example: how a CVE fix to component A results in downtime of other components or the overarching application; how long does a routine maintenance task for component B typically take; how long does a minor version release; how long does a major version release take; or does a patch version release typically result in downtime for component C and other components in the system.

The training data 308 may include a classification of a maintenance task performed, tied to a component that the maintenance task is performed by (and fOr), downtime of any of the components (e.g., a duration), if any, and a timestamp for each downtime that occurred. Downtime may be determined by monitoring each component and the overarching application to determine whether it is behaving as intended (e.g., if the component is responsive, operational, if performance is sufficient).

The machine learning model 318 may include time as a distance metric in the time series clustering algorithm such that temporally aligned downtimes of the different components are clustered together. For example, machine learning model 318 may process the training data 308 and determine that component A, component B, and component C experience downtime at similar times for similar lengths of time. As such, machine learning model 318 may cluster these components together in metadata 320. In some examples, the distance metric of the algorithm may use dynamic time warping to find accurate correlations between components (e.g., interdependencies).

The components within a cluster may be understood as being interdependent on one another. For example, if component A and component B are clustered together by the machine learning model 318, and component A is expected to have a downtime in response to a given maintenance task, then component B is also expected to have a downtime in response to the downtime of component A.

The machine learning model 318 may generate a time-based downtime graph that depicts the chain effects of downtime starting from a root component (e.g., the component for which the maintenance task is applied). This may be generated for each combination of component and classification type. The number of graphs may be as numerous as the number of independently deployable components multiplied with the number of classification types. The machine learning model 318 may generate correlations between each maintenance task classification and each component, with an expected downtime of that component and other components in the application, and timings of each downtime. These correlations may be generated for each permutation of classification and component.

As such, machine learning model 318 may generate metadata 320 with expected downtimes 322 of each component in response to a given classification of the maintenance task, as supported by the monitoring of the application 302 and its components 304. The expected downtime 322 may be specific to a component and its expected response to a given classification. The expected response describes whether or not the component will experience downtime and for how long.

In such a manner, metadata generator and scheduler 306 may generate metadata 320 by monitoring the applications 302 in response to past maintenance tasks. The metadata generator and scheduler 306 may use this metadata 320 to opportunistically schedule future maintenance tasks, such that an overall downtime of application 302 is reduced. Past maintenance tasks may be understood as maintenance tasks that have been performed. Unperformed maintenance tasks may be maintenance tasks that have yet to be performed.

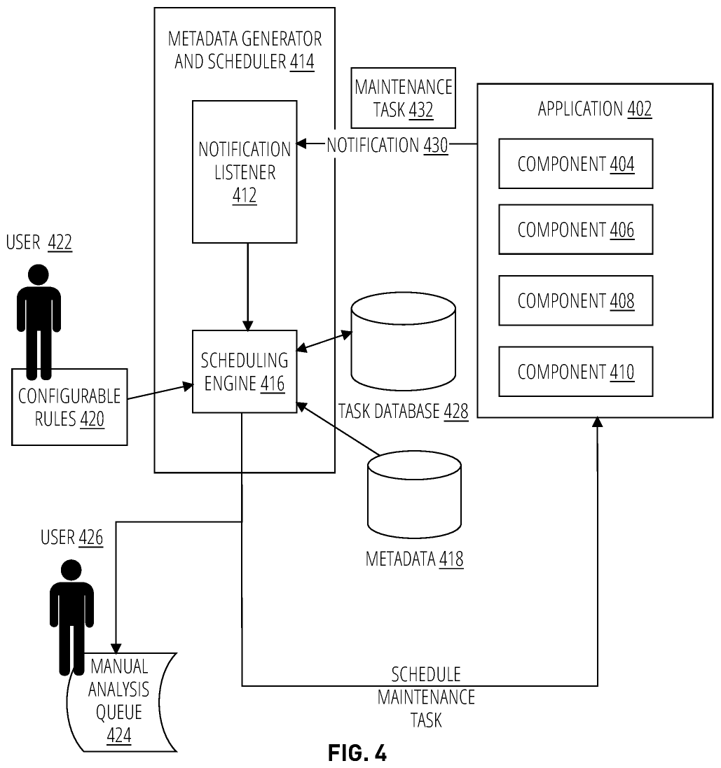

FIG. 4 shows an example workflow for scheduling maintenance tasks of components in view of metadata, in accordance with some embodiments. As discussed, metadata generator and scheduler 414 may generate metadata 418 from monitoring of a plurality of components (e.g., components 404, 406, 408, and 410) of an application 402 in response to past maintenance tasks. Metadata generator and scheduler 414 may use this metadata 418 to schedule maintenance tasks for each of these components.

Metadata generator and scheduler 414 may have a notification listener 412 that listens for notifications (e.g., notification 430) which may be received from application 402. A component may initiate a notification for each maintenance task that is to be performed for or by the component. The notification listener 412 may obtain notification 430 to perform the maintenance task 432 for a first of the plurality of components. For example, component 404 may generate a notification 430 that indicates a maintenance task 432 having a classification of ‘minor version release’ which is to be performed by component 404. More generally, each of the components of the application 402 may generate a notification 430 (e.g., a request) that may include a maintenance task 432 and a respective classification.

Metadata generator and scheduler 414 may reference the metadata 418 in view of the maintenance task 432. The metadata 414 may indicate to the metadata generator and scheduler 414, an expected downtime of a first of the plurality of components (e.g., component 404) and a second expected downtime of a second of the plurality of components (e.g., component 406) in response to the expected downtime of the first of the plurality of components. As such, the metadata may indicate interdependencies between the components of the application 402.

Metadata generator and scheduler 414 may schedule the maintenance task for the first of the plurality of components (e.g., component 404) to coincide with a second maintenance task of the second of the plurality of components (e.g., component 406). In such a manner, maintenance tasks may be performed on multiple components at the same time, so that their respective downtimes overlap rather than spread out. Otherwise, if the maintenance tasks are instead scheduled at different non-overlapping times, then application 402 may experience downtime when the maintenance task is performed for component 404 and again, when the second maintenance task is performed for component 406. Thus, the metadata generator and scheduler 414 is able to reduce the overall downtime of application 402 by referring to interdependencies in metadata 418.

Further, metadata generator and scheduler 414 may look at other maintenance tasks that are stored in a maintenance task database 428 to determine if maintenance tasks are pending for components of application 402. Metadata generator and scheduler 414 may schedule pending maintenance tasks that also have an expected downtime, together with maintenance task 432 that is indicated in the notification 430.

For example, components 408 and 410 may have ‘routine maintenance’ tasks that are pending and stored in task database 428. The ‘routine maintenance’ task for component 408 may have an expected downtime of ‘x’, while the ‘routine maintenance’ task for component 410 may have an expected downtime of ‘y’. The metadata generator and scheduler 414 may schedule both of these maintenance tasks to coincide with the maintenance task of component 404 and component 406, to further reduce the overall downtime of application 402.

In some embodiments, the metadata generator and scheduler 414 may schedule the pending tasks with the maintenance task signaled in the notification, in response to the tasks being within threshold duration of each other. For example, if the component that is to perform maintenance task 432 has an expected downtime ‘z’, and downtime ‘x’ associated with the pending maintenance task for component 408 exceeds ‘z’ by a threshold time t, then that pending maintenance task associated with downtime ‘x’ may not be scheduled with maintenance task 432. On the other hand, if the expected downtime ‘y’ of the pending maintenance task for component 410 is smaller than ‘z’, or this expected downtime ‘y’ is within a threshold time t of ‘z’, metadata generator and scheduler 414 may schedule this pending maintenance task for component 410 to run at the same time as maintenance task 432 for component 404. As such, the metadata generator and scheduler 414 may schedule maintenance tasks in a manner that grows the downtime slightly (as determined by the threshold time t) or not at all (when the concurrent maintenance tasks have a smaller expected downtime).

Further, metadata generator and scheduler 414 may schedule the pending maintenance task for component 406 to also run at the same time with maintenance task 432, in response to an interdependency of component 406 to component 404, as indicated by the metadata 418. As such, metadata generator and scheduler 414 may schedule maintenance tasks together in view of interdependencies or according to similarity in expected downtime, or both, thereby reducing overall downtime of the application.

Further, the scheduling engine 416 may refer to configurable rules 420 to determine a date and time to schedule the maintenance tasks. Configurable rules 420 may be exposed to a user 422, who may have domain knowledge as to how the maintenance tasks should be prioritized in scheduling. For example, user 422 may configure the rules so that maintenance tasks with some classifications or sub-classifications are run periodically, and maintenance tasks for other classifications are run immediately. In some examples, the configurable rules 420 may prioritize maintenance tasks of some components over others.

Configurable rules 420 may be domain specific, to provide users with a flexibility and command over scheduling maintenance tasks. For example, a user 422 may set a rule that specifies that all tasks are to be run on a specific day or time of day. The user may specify this day or time to be when usage of the application is known to be at its lowest. In another example, a user may set a time matching tolerance (e.g., a threshold time t) whereby the metadata generator and scheduler 414 may schedule a maintenance task A concurrently with a maintenance task B if maintenance task A has an expected downtime that is less than that of task B or if maintenance task A has an expected downtime that is greater than task B, but by less than the threshold time t.

In some examples, configurable rules may have override logic that defines when some maintenance tasks are to be performed. For example, a user may specify that all maintenance tasks for component A are to be performed periodically at a specified time, or that any maintenance task with classification of ‘CVE upgrade’ is to be performed immediately for component B. Thus, the configurable rules may allow a user to tailor the scheduling of maintenance tasks according to domain knowledge that is specific to a given application and override automated scheduling logic.

In some examples, a user 422 may categorize CVE maintenance tasks or other maintenance tasks. These categories may include, for example, whether the task is to be applied immediately, queued, scheduled, or ignored. The rules engine may specify how to categorize CVE maintenance tasks in view of a CVE criticality (e.g., critical, high, medium, or low). This may be done on a per component basis depending on the risk or criticality of the component.

For example, configurable rules 420 may specify that, for component A, a maintenance task with a category of ‘CVE critical’ is to be applied immediately. In another example, configurable rules 420 may specify that, for component A, a maintenance task with a category of ‘CVE high’ is to be queued. In another example, configurable rules 420 may specify that, for component A, a maintenance task with a category of ‘CVE medium’ is to be scheduled. In another example, configurable rules 420 may specify that, for com ponent A, a maintenance task with a category of ‘CVE low’ is to be ignored.

Scheduling engine 416 may send such maintenance tasks to a manual analysis queue (such as manual analysis queue 424 shown in FIG. 4). A user 426 may evaluate the queued maintenance tasks and flag each to be applied immediately, scheduled, or ignored. The scheduling engine 416 may then pull the task off the queue and schedule it according to the flag. As such, the metadata generator and scheduler 414 may allow a user 422 to configure rules such that scheduling of select maintenance tasks involves manual evaluation by user 426, while the rest of the scheduling is automated. User 422 and user 426 may be the same user or a different user.

Scheduling engine 416 may update schedule date and times with each component periodically, or anytime a new notification is received, or both. In some examples, the scheduling engine 416 may maintain a date and time for when each maintenance task is scheduled to be performed. Additionally, or alternatively, scheduling engine 416 may communicate this date and time to each component so that each component will perform the respective maintenance task at that date and time. The date and time for each maintenance task may be stored and managed with various techniques.

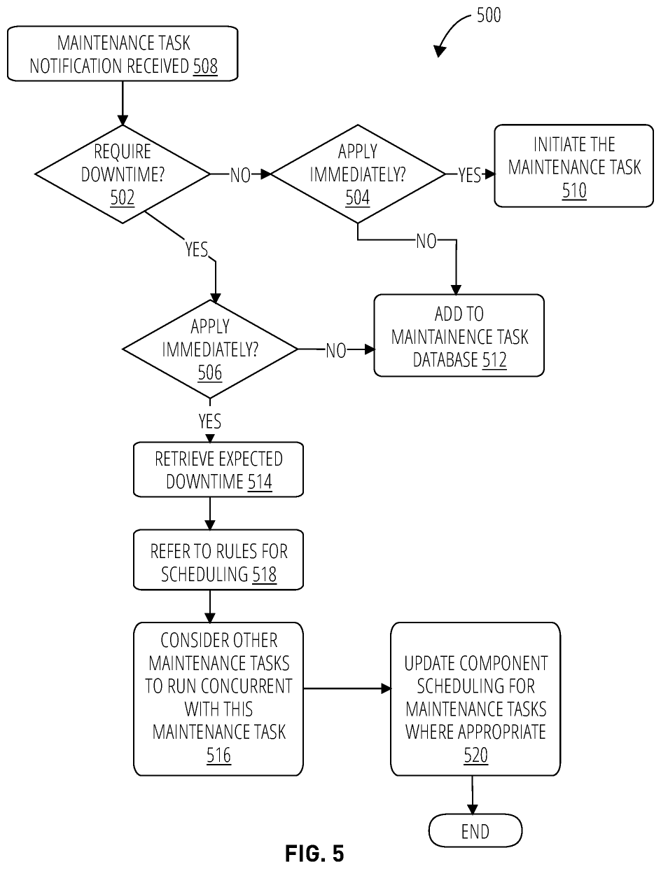

FIG. 5 illustrates an example of scheduling logic 500 in accordance with some embodiments. Scheduling logic 500 may be implemented by processing logic, such as, for example, a metadata generator and scheduler as described in other sections. Scheduling logic 500 may be performed in response to each notification of each maintenance task or periodically, or both.

At block 508, processing logic may obtain a notification that indicates that a maintenance task is to be performed on a component of an application. The notification may include a classification of the maintenance task.

At block 502, processing logic may determine if the maintenance task requires downtime, by referencing metadata to determine an expected downtime of a component in response to a given maintenance task. If the maintenance task does not have an expected downtime, then processing logic may evaluate, at block 504, if the maintenance task is to be applied immediately. In some examples, the notification may indicate whether or not the maintenance task is to be applied immediately. In some examples, configured rules may indicate which of one or more classifications of maintenance tasks are to be applied immediately, or that maintenance tasks for some components are to be applied immediately, or a combination thereof.

In response to the maintenance task being flagged for applying immediately, processing logic may proceed to block 510 and initiate the maintenance task. Processing logic may initiate the maintenance task by messaging the application or component thereof, to perform the maintenance task. The component may then perform the maintenance task.

In response to the maintenance task not being flagged for applying immediately, processing logic may proceed to block 512 and add the maintenance task to a maintenance task database. This maintenance task can be stored in the database and scheduled to run with other maintenance tasks opportunistically, as described in other sections.

At block 502, in response to the maintenance task having an expected downtime, processing logic may proceed to block 506 and evaluate whether the maintenance task is to be applied immediately, as described. If not, then processing logic may proceed to block 512 and add the maintenance task to a maintenance task database, as described.

At block 506, in response to the maintenance task being flagged for applying immediately (and in response to the maintenance task having an expected downtime as determined at block 502), processing logic may proceed to block 514 and retrieve the expected downtime. The expected downtime may be obtained by referencing metadata generated in view of historical data, as described.

Processing logic may proceed to block 518 and refer to configured rules for scheduling. Configured rules may indicate the time or date for which a next mandatory maintenance task is to be scheduled by processing logic. For example, processing logic may reference the current pending maintenance tasks in view of the configured rules to determine a ‘next schedule date’ at which at least one of the pending maintenance tasks must be run by, according to the configured rules. This ‘next schedule date’ may serve as a baseline for processing logic to schedule the maintenance tasks. For example, processing logic may schedule this next mandatory maintenance task with the current maintenance task and others in view of expected downtime and interdependency.

Processing logic may proceed to block 516 and consider other maintenance tasks to run concurrent with the maintenance task that is received through the notification. As discussed, processing logic may schedule pending maintenance tasks for other components that are deemed to be interdependent on the component for which the maintenance task (initially signaled in the notification) is to be performed on. Additionally, or alternatively, processing logic may schedule pending maintenance tasks for components that have an expected downtime that is smaller than or within a threshold to the duration of the expected downtime of the maintenance task initially signaled in the notification, as described. In some examples, processing logic may schedule pending maintenance tasks for components that have an expected downtime that is smaller than or equal to the duration of the expected downtime of the maintenance task initially signaled in the notification.

At block 520, processing logic may update component scheduling for maintenance tasks where appropriate. For example, the maintenance task that is received in the notification at block 508 may change the time of previously scheduled maintenance tasks which may or may not be pending. Processing logic may message the application or each component to update the date and time for that component to perform the maintenance task. Each new notification received by processing logic may have an impact on scheduled of pending maintenance tasks.

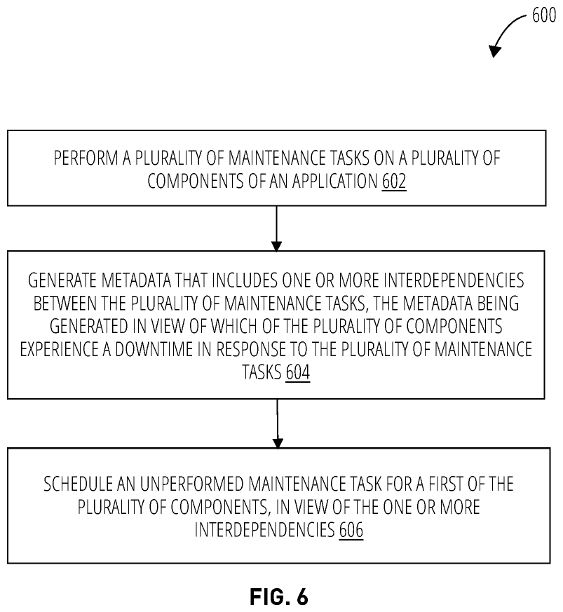

FIG. 6 is a flow diagram of a method 600 for scheduling maintenance tasks for components, in accordance with some embodiments. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 600 may be performed by metadata generator and scheduler 108 of FIG. 1.

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

At block 602, processing logic performs a plurality of maintenance tasks on a plurality of components of an application.

At block 604, processing logic generates metadata that includes one or more interdependencies between the plurality of maintenance tasks, the metadata being generated in view of which of the plurality of components experience a downtime in response to the plurality of maintenance tasks.

At block 606, processing logic schedules an unperformed maintenance task for a first of the plurality of components, in view of the one or more interdependencies.

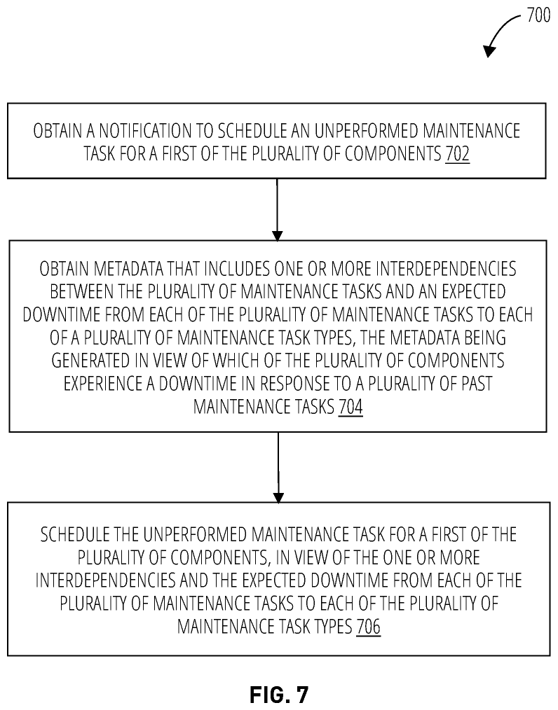

FIG. 7 is a flow diagram of a method 700 for scheduling maintenance tasks for components, in accordance with some embodiments. Method 700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 700 may be performed by metadata generator and scheduler 108 of FIG. 1.

With reference to FIG. 7, method 700 illustrates example functions used by various embodiments. Although specific function blocks (“blocks”) are disclosed in method 700, such blocks are examples. That is, embodiments are well suited to performing various other blocks or variations of the blocks recited in method 700. It is appreciated that the blocks in method 700 may be performed in an order different than presented, and that not all of the blocks in method 700 may be performed.

At block 702, processing logic obtains a notification to schedule an unperformed maintenance task for a first of the plurality of components.

At block 704, processing logic obtains metadata that includes one or more interdependencies between the plurality of maintenance tasks and an expected downtime from each of the plurality of maintenance tasks to each of a plurality of maintenance task types, the metadata being generated in view of which of the plurality of components experience a downtime in response to a plurality of past maintenance tasks.

At block 706, processing logic schedules the unperformed maintenance task for a first of the plurality of components, in view of the one or more interdependencies and the expected downtime from each of the plurality of maintenance tasks to each of the plurality of maintenance task types. For example, metadata may include an expected downtime (which may include zero expected downtime) for each combination of a given maintenance task type and a given one of the plurality of components.

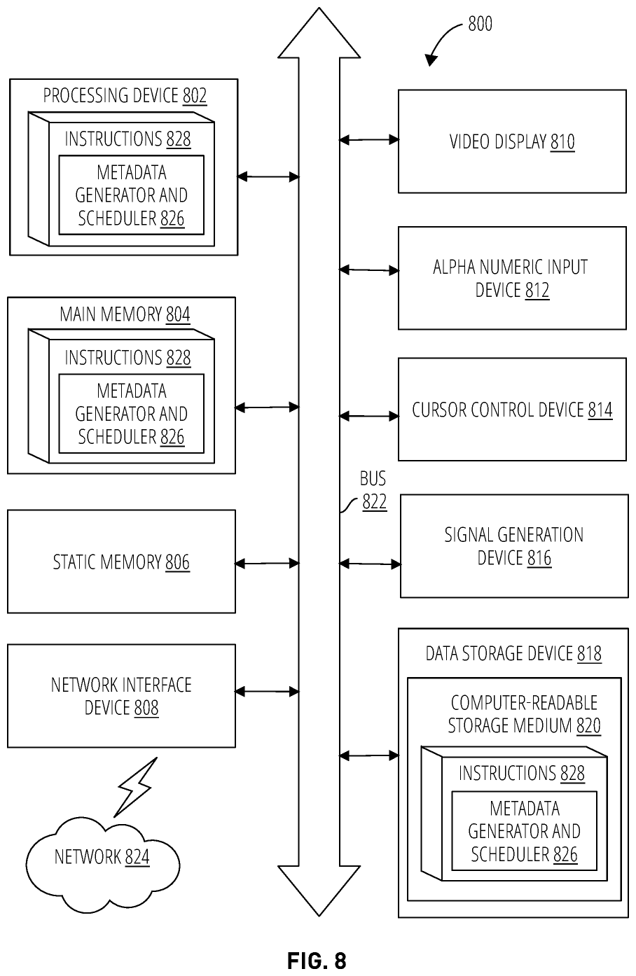

FIG. 8 is a block diagram of an example computing device 800 that may perform one or more of the operations described herein, in accordance with some embodiments. For example, the computing device may schedule a maintenance task in view of an expected downtime of the maintenance task which is given in metadata.

Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device 802 (e.g., a general purpose processor, a PLD, etc.), a main memory 804 (e.g., synchronous dynamic random access memory (DRAM), read-only memory (ROM)), a static memory 806 (e.g., flash memory and a data storage device 818), which may communicate with each other via a bus 822.

Processing device 802 may be provided by one or more general-purpose processing devices such as a microprocessor, central processing unit, or the like. In an illustrative example, processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also comprise one or more special-purpose processing devices such as an application specific integrated circuit (ASIC), a field programmable gate array (FPGA), a digital signal processor (DSP), network processor, or the like. The processing device 802 may be configured to execute the operations described herein, in accordance with one or more aspects of the present disclosure, for performing the operations and steps discussed herein.

Computing device 800 may further include a network interface device 808 which may communicate with a network 824. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 820 on which may be stored one or more sets of instructions 828 that may include instructions for a processing device (e.g., processing device 104), for carrying out the operations described herein, in accordance with one or more aspects of the present disclosure. Instructions 828 may also reside, completely or at least partially, within main memory 804 and/or within processing device 802 during execution thereof by computing device 800, main memory 804 and processing device 802 also constituting computer-readable media. The instructions 828 may further be transmitted or received over a network 824 via network interface device 808. The instructions 828 may contain instructions of a metadata generator and scheduler 826 that, when executed, perform the operations and steps discussed herein.

While computer-readable storage medium 820 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Example 1 is a method comprising: generating, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components; obtaining, by the processing device, a notification to perform a maintenance task for a first of the plurality of components; and in view of the metadata, scheduling, by the processing device, the maintenance task for the first of the plurality of components to coincide with a second maintenance task of the second of the plurality of components.

Example 2 is the method of Example 1, wherein generating the metadata comprises identifying, by the processing device, one or more of the plurality of components that experienced a downtime in response to the past maintenance tasks.

Example 3 is the method of any of Examples 1-2, wherein generating the metadata comprises providing, by the processing device, records of the downtime of the plurality of components to a machine learning model in response to the past maintenance tasks.

Example 4 is the method of any of Examples 1-3, wherein generating the metadata comprises classifying, by the processing device, each of the past maintenance tasks, and providing the classifications of the past maintenance tasks to the machine learning model, wherein the machine learning model processes the classifications of the past maintenance tasks to associate the downtime of each of the plurality of components to each of the classifications, and to each of the plurality of components of the application.

Example 5 is the method of any of Examples 1-4, wherein the classifications comprise at least two of: a major version release, a minor version release, a patch version release, a routine maintenance, and a common vulnerabilities and exposures (CVE) upgrade.

Example 6 is the method of any of Examples 1-5, wherein the machine learning model comprises a time series clustering algorithm.

Example 7 is the method of any of Examples 1-6, wherein the machine learning model comprises time as a distance metric in the time series clustering algorithm.

Example 8 is the method of any of Examples 1-7, wherein scheduling, by the processing device, the maintenance task for the first of the plurality of components to coincide with a second maintenance task of the second of the plurality of components, comprises: referencing, by the processing device, a classification of the maintenance task with respect to the first of the plurality of components in the metadata to determine whether the first of the plurality of components has the expected downtime in response to the maintenance task and determining which of the plurality of components is expected to have the second expected downtime in response to the expected downtime of the first of the plurality of components.

Example 9 is the method of any of Examples 1-8, further comprising scheduling, by the processing device, the maintenance task for the first of the plurality of components for immediate performance, in response to the first of the plurality of components not expected to have a downtime in response to the maintenance task.

Example 10 is the method of any of Examples 1-9, wherein scheduling the maintenance task comprises scheduling, by the processing device, a third maintenance task of a third of the plurality of components in response to the third maintenance task a third expected downtime that is smaller than expected downtime of the first of the plurality of components, or greater than the expected downtime of the first of the plurality of components by less than a threshold amount.

Example 11 is the method of any of Examples 1-10, wherein scheduling the maintenance task is determined in view of a set of rules that is configurable by a user.

Example 12 is the method of any of Examples 1-11, further comprising queuing the maintenance task for manual analysis.

Example 13 is a system comprising: a memory; and a processing device operatively coupled to the memory, the processing device to: generate, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components; obtain, by the processing device, a notification to perform a maintenance task fora first of the plurality of components; and in view of the metadata, schedule, by the processing device, the maintenance task for the first of the plurality of components to coincide with a second maintenance task of the second of the plurality of components.

Example 14 is the system of Example 13, wherein to generate the metadata comprises to identify, by the processing device, one or more of the plurality of components that experienced a downtime in response to the past maintenance tasks.

Example 15 is the system of any of Examples 13-14, wherein to generate the metadata comprises to provide, by the processing device, records of the downtime of the plurality of components to a machine learning model in response to the past maintenance tasks.

Example 16 is the system of any of Examples 13-15, wherein to generate the metadata comprises to classify, by the processing device, each of the past maintenance tasks, and to provide the classifications of the past maintenance tasks to the machine learning model, wherein the machine learning model processes the classifications of the past maintenance tasks to associate the downtime of each of the plurality of components to each of the classifications, and to each of the plurality of components of the application.

Example 17 is a non-transitory computer-readable storage medium including instructions that, when executed by a processing device, cause the processing device to: generate, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components; obtain, by the processing device, a notification to perform a maintenance task for a first of the plurality of components; and in view of the metadata, schedule, by the processing device, the maintenance task for the first of the plurality of components to coincide with a second maintenance task of the second of the plurality of components.

Example 18 is the non-transitory computer-readable storage medium of Example 17, wherein to generate the metadata comprises to identify, by the processing device, one or more of the plurality of components that experienced a downtime in response to the past maintenance tasks.

Example 19 is the non-transitory computer-readable storage medium of any of Example 17-18, wherein generating the metadata comprises to provide, by the processing device, records of the downtime of the plurality of components to a machine learning model in response to the past maintenance tasks.

Example 20 is the non-transitory computer-readable storage medium of any of Example 17-19, wherein to generate the metadata comprises to classify, by the processing device, each of the past maintenance tasks, and to provide the classifications of the past maintenance tasks to the machine learning model, wherein the machine learning model processes the classifications of the past maintenance tasks to associate the downtime of each of the plurality of components to each of the classifications, and to each of the plurality of components of the application.

Example 21 is a method comprising: performing, by a processing device, a plurality of maintenance tasks on a plurality of components of an application; generating, by a processing device, metadata that comprises one or more interdependencies between the plurality of maintenance tasks, the metadata being generated in view of which of the plurality of components experience a downtime in response to the plurality of maintenance tasks; and scheduling, by the processing device, an unperformed maintenance task for a first of the plurality of components, in view of the one or more interdependencies.

Example 22 is the method of Example 21, wherein scheduling, by the processing device, the unperformed maintenance task for the first of the plurality of components, comprises scheduling the first of the plurality of components to coincide with a second maintenance task of the second of the plurality of components such that an overall downtime of the application is reduced.

Example 23 is the method of any of Examples 21-22, wherein the metadata comprises an expected downtime of the first of the plurality of components and a second expected downtime of a second of the plurality of components in response to the expected downtime of the first of the plurality of components.

Example 24 is the method of any of Examples 21-23, wherein generating the metadata comprises providing, by the processing device, records of each downtime of each of the plurality of components to a machine learning model in response to the plurality of maintenance tasks.

Example 25 is the method of any of Examples 21-24, wherein each of the records that is fed into the machine learning model is classified in view of a plurality of maintenance task types, which associates the downtime of each of the plurality of components to each of the maintenance task types.

Example 26 is a system comprising: a memory; and a processing device operatively coupled to the memory, the processing device to: obtain, by the processing device, a notification to schedule an unperformed maintenance task for a first of the plurality of components; obtain, by the processing device, metadata that comprises one or more interdependencies between the plurality of maintenance tasks and an expected downtime from each of the plurality of maintenance tasks to each of a plurality of maintenance task types, the metadata being generated in view of which of the plurality of components experience a downtime in response to a plurality of past maintenance tasks; and schedule, by the processing device, the unperformed maintenance task for a first of the plurality of components, in view of the one or more interdependencies and the expected downtime from each of the plurality of maintenance tasks to each of the plurality of maintenance task types.

Example 27 is the system of Example 26, wherein to schedule, by the processing device, the unperformed maintenance task for the first of the plurality of components, comprises to schedule the first of the plurality of components to coincide with a second maintenance task of the second of the plurality of components such that an overall downtime of the application is reduced.

Example 28 is the system of any of Examples 26-27, wherein the metadata comprises a first expected downtime of the first of the plurality of components and a second expected downtime of a second of the plurality of components in response to the first expected downtime of the first of the plurality of components, wherein a second unperformed maintenance task of the second of the plurality of components is scheduled by the processing device, to coincide with the unperformed maintenance task of the first of the plurality of components.

Example 29 is the system of any of Examples 26-28, wherein generating the metadata comprises providing, by the processing device, records of each downtime of each of the plurality of components to a machine learning model in response to the past maintenance tasks.

Example 30 is the system of any of Examples 26-29, wherein each of the records that is fed into the machine learning model is labeled with one of the plurality of maintenance task types, which associates the expected downtime of each of the plurality of components to each of the maintenance task types.

Example 31 is an apparatus comprising: means for generating, by a processing device, metadata in view of monitoring a response of each of a plurality of components of an application to past maintenance tasks; means for obtaining, by the processing device, a notification to perform a maintenance task for a first of the plurality of components; means for referencing, by the processing device, the metadata in view of the maintenance task, the metadata indicating an expected downtime of a first of the plurality of components and a second expected downtime of a second of the plurality of components in response to the expected downtime of the first of the plurality of components; and means for scheduling, by the processing device, the maintenance task for the first of the plurality of components to coincide with a second maintenance task of the second of the plurality of components.

Example 32 is the apparatus of Example 31, wherein generating the metadata comprises capturing, by the processing device, which of the plurality of components experienced a downtime in response to the past maintenance tasks.

Example 33 is the apparatus of any of Examples 31-32, wherein generating the metadata comprises providing, by the processing device, records of the downtime of the plurality of components to a machine learning model in response to the past maintenance tasks.

Example 34 is the apparatus of any of Examples 31-33, wherein generating the metadata comprises classifying, by the processing device, each of the past maintenance tasks, and providing the classifications of the past maintenance tasks to the machine learning model, which the machine learning model processes to associate the downtime of each of the plurality of components to each of the classifications, and to each of the plurality of components of the application.

Example 35 is the apparatus of any of Examples 31-34, wherein the classifications comprise at least two of: a major version release, a minor version release, a patch version release, a routine maintenance, and a common vulnerabilities and exposures (CVE) upgrade.

Unless specifically stated otherwise, terms such as “obtaining”, “receiving,”, “referencing”, “routing,” “updating,” “providing,”, “scheduling”, “monitoring”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
generating, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components;
obtaining, by the processing device, a notification to perform a maintenance task for a first of the plurality of components; and
in view of the metadata, scheduling, by the processing device, the maintenance task for the first of the plurality of components to coincide with a second maintenance task of the second of the plurality of components.

2. The method of claim 1, wherein generating the metadata comprises identifying, by the processing device, one or more of the plurality of components that experienced a downtime in response to the past maintenance tasks.

3. The method of claim 2, wherein generating the metadata comprises providing, by the processing device, records of the downtime of the plurality of components to a machine learning model in response to the past maintenance tasks.

4. The method of claim 3, wherein generating the metadata comprises classifying, by the processing device, each of the past maintenance tasks, and providing the classifications of the past maintenance tasks to the machine learning model, wherein the machine learning model processes the classifications of the past maintenance tasks to associate the downtime of each of the plurality of components to each of the classifications.

5. The method of claim 4, wherein the classifications comprise at least two of: a major version release, a minor version release, a patch version release, a routine maintenance, and a common vulnerabilities and exposures (CVE) upgrade.

6. The method of claim 3, wherein the machine learning model comprises a time series clustering algorithm.

7. The method of claim 6, wherein the machine learning model comprises time as a distance metric in the time series clustering algorithm.

8. The method of claim 1, wherein scheduling, by the processing device, the maintenance task for the first of the plurality of components to coincide with a second maintenance task of the second of the plurality of components, comprises: referencing, by the processing device, a classification of the maintenance task with respect to the first of the plurality of components in the metadata to determine whether the first of the plurality of components has the expected downtime in response to the maintenance task and determining which of the plurality of components is expected to have the second expected downtime in response to the expected downtime of the first of the plurality of components.

9. The method of claim 1, further comprising scheduling, by the processing device, the maintenance task for the first of the plurality of components for immediate performance, in response to the first of the plurality of components not expected to have a downtime in response to the maintenance task.

10. The method of claim 1, wherein scheduling the maintenance task comprises scheduling, by the processing device, a third maintenance task of a third of the plurality of components in response to the third maintenance task a third expected downtime that is smaller than expected downtime of the first of the plurality of components, or greater than the expected downtime of the first of the plurality of components by less than a threshold amount.

11. The method of claim 1, wherein scheduling the maintenance task is determined in view of a set of rules that is configurable by a user.

12. The method of claim 1, further comprising queuing the maintenance task for manual analysis.

13. A system comprising:
a memory; and
a processing device operatively coupled to the memory, the processing device to:
generate, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components;
obtain, by the processing device, a notification to perform a maintenance task for a first of the plurality of components; and
in view of the metadata, schedule, by the processing device, the maintenance task for the first of the plurality of components to coincide with a second maintenance task of the second of the plurality of components.

14. The system of claim 13, wherein to generate the metadata comprises to identify, by the processing device, one or more of the plurality of components that experienced a downtime in response to the past maintenance tasks.

15. The system of claim 14, wherein to generate the metadata comprises to provide, by the processing device, records of the downtime of the plurality of components to a machine learning model in response to the past maintenance tasks.

16. The system of claim 15, wherein to generate the metadata comprises to classify, by the processing device, each of the past maintenance tasks, and to provide the classifications of the past maintenance tasks to the machine learning model, wherein the machine learning model processes the classifications of the past maintenance tasks to associate the downtime of each of the plurality of components to each of the classifications.

17. A non-transitory computer-readable storage medium including instructions that, when executed by a processing device, cause the processing device to:
generate, by a processing device, metadata in view of monitoring a response of each of a plurality of components of an application to past maintenance tasks, wherein the metadata comprises an expected downtime of a first of the plurality of components of the application and a second expected downtime of a second of the plurality of components of the application in response to the expected downtime of the first of the plurality of components;
obtain, by the processing device, a notification to perform a maintenance task for a first of the plurality of components; and
in view of the metadata, schedule, by the processing device, the maintenance task for the first of the plurality of components to coincide with a second maintenance task of the second of the plurality of components.

18. The non-transitory computer-readable storage medium of claim 17, wherein to generate the metadata comprises to identify, by the processing device, one or more of the plurality of components that experienced a downtime in response to the past maintenance tasks.

19. The non-transitory computer-readable storage medium of claim 18, wherein generating the metadata comprises to provide, by the processing device, records of the downtime of the plurality of components to a machine learning model in response to the past maintenance tasks.

20. The non-transitory computer-readable storage medium of claim 19, wherein to generate the metadata comprises to classify, by the processing device, each of the past maintenance tasks, and to provide the classifications of the past maintenance tasks to the machine learning model, wherein the machine learning model processes the classifications of the past maintenance tasks to associate the downtime of each of the plurality of components to each of the classifications.
